(19) United States
(12) Patent Application Publication
(10) Pub. No.: US 2016/0335734 A1
(43) Pub. Date: Nov. 17, 2016

(54) MEMORY SUBSYSTEM SYNCHRONIZATION PRIMITIVES

(71) Applicant: ViXS Systems, Inc., Toronto (CA)

(72) Inventor: Brian Lee, Markham (CA)

(21) Appl. No.: 14/853,099

(22) Filed: Sep. 14, 2015

Related U.S. Application Data
(60) Provisional application No. 62/159,658, filed on May 11, 2015.

(51) Int. Cl. G06T 1/20; H04N 5/44; H04N 5/262; G06T 1/60; H04N 7/56

(52) U.S. Cl. CPC G06T 1/20; G06T 1/60; H04N 7/56; H04N 5/262; H04N 5/4401

(57) ABSTRACT

An apparatus includes a first data processor configured to communicate first data and handshake information to a non-coherent memory system. The apparatus includes a second data processor coupled in a pipeline with the first data processor and configured to execute in parallel with the first data processor. The second data processor is configured to read the first data from the non-coherent memory system in response to receiving an indicator from the non-coherent memory system based on the handshake information. The apparatus may include the non-coherent memory system. The non-coherent memory system may include a memory controller configured to receive the first data and the handshake information, the memory controller being configured to provide the indicator in response to the first data being available for a read.

### CROSS-REFERENCE TO RELATED APPLICATION(S)

This application claims benefit under 35 U.S.C. §119(e) of provisional application 62/159,658 filed May 11, 2015, entitled “MEMORY SUBSYSTEM SYNCHRONIZATION PRIMITIVES”, naming Brian Lee as inventor, which application is incorporated herein by reference.

### BACKGROUND

1. Field of the Invention

This application is related to data processing systems and more particularly to pipelined data processing systems.

2. Description of the Related Art

A typical video data processing system includes a video system on a chip (SoC) integrated circuit including multiple video processing blocks and related hardware. The video SoC receives compressed video data and decompresses (i.e., decodes, uncompresses, or expands) the compressed video data to recover uncompressed (i.e., raw) video data. The video SoC writes the uncompressed video data to a buffer or a system memory for subsequent use by one or more video processing blocks. The one or more video processing blocks retrieve the uncompressed video data from the buffer or system memory and may write processed, uncompressed video data to another buffer or other portion of system memory. In general, a still video image or frame includes R×C pixels (e.g., 1920×1080 pixels for an exemplary high-definition video screen) and each pixel may be represented by multiple bytes of data. A video processing block reads a frame, or portions of a frame of video data from a buffer or the system memory, processes the video data, and, in some cases, writes the processed video data to another buffer or back to the system memory.

### SUMMARY OF EMBODIMENTS OF THE INVENTION

In at least one embodiment of the invention, an apparatus includes a first data processor configured to communicate first data and handshake information to a non-coherent memory system. The apparatus includes a second data processor coupled in a pipeline with the first data processor and configured to execute in parallel with the first data processor. The second data processor is configured to read the first data from the non-coherent memory system in response to receiving an indicator from the non-coherent memory system based on the handshake information. The apparatus may include the non-coherent memory system. The non-coherent memory system may include a memory controller configured to receive the first data and the handshake information, the memory controller being configured to provide the indicator in response to the first data being available for a read. The memory controller may be configured to provide the indicator to the second data processor in response to the first data being committed to the memory system. The indicator signal may be based on a size of the write, a write start indicator, or a write finish indicator. The memory controller may be configured to write first data out of order to the non-coherent memory system. The first data processor may write the first data to the non-coherent memory system in a first order and the second data processor may read the first data from the non-coherent memory system in a second order.

In at least one embodiment of the invention, a method includes writing first data to a non-coherent memory system. The data is received from a first processor in a pipeline of processors executing in parallel. The method includes providing handshake information to the non-coherent memory system. The method includes detecting an indicator by a second processor of the pipeline of processors, the indicator being based on the handshake information and indicating that the first data is available for a read. The method includes reading the first data from the non-coherent memory system in response to detecting the indicator. The method may include storing the data in the non-coherent memory system and receiving the handshake information from the first processor. The method may include generating the indicator based on the handshake information and providing the indicator to the second processor. The first data processor may write the first data to the non-coherent memory system in a first order and the second data processor may read the first data from the non-coherent memory system in a second order.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary pipelined video processing system.

FIG. 2 illustrates an exemplary video data format of a frame of a still video image.

FIG. 3 illustrates an exemplary video data format of a fundamental block of a frame of a still video image of FIG. 2.

FIG. 4 illustrates a functional block diagram of an exemplary portion of a pipelined video processing system.

FIG. 5 illustrates a functional block diagram of an exemplary portion of the pipelined video processing system of FIG. 1.

FIG. 6 illustrates a functional block diagram of an exemplary portion of a pipelined video processing system consistent with at least one embodiment of the invention.

FIG. 7 illustrates exemplary information and control flows for the portion of the pipelined video processing system of FIG. 6 consistent with at least one embodiment of the invention.

The use of the same reference symbols in different drawings indicates similar or identical items.

### DETAILED DESCRIPTION

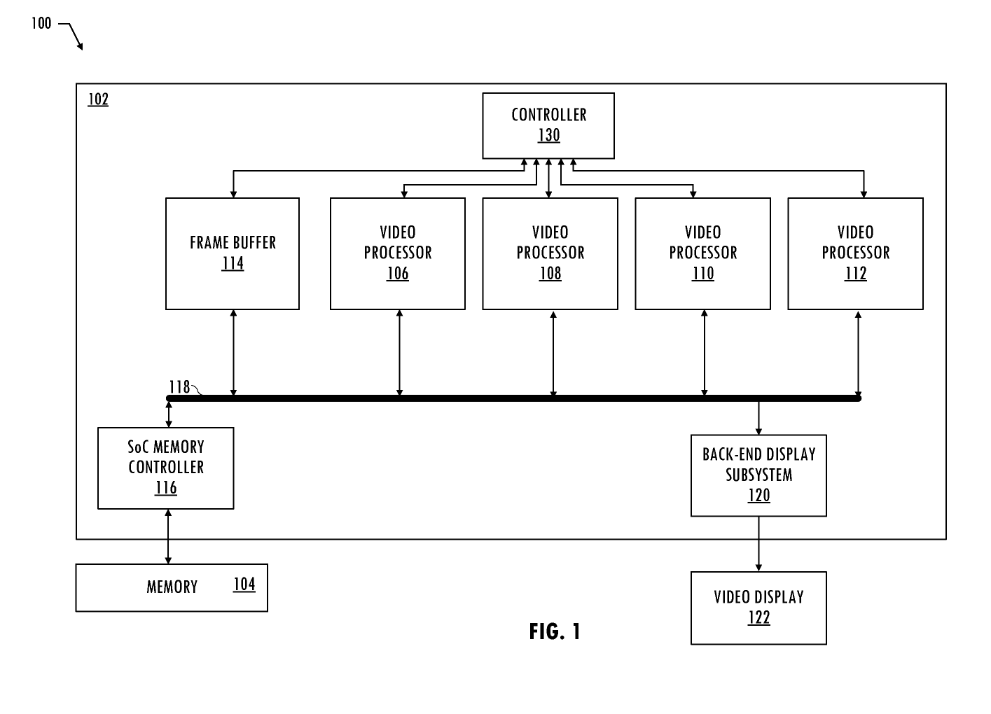

Referring to FIG. 1, a typical video data processing system includes system memory 104 and a video system-on-a-chip (SoC) 102, which includes memory controller 116 and multiple video processing circuits and associated circuits coupled in an pipeline. Video SoC 102 receives compressed video data from memory 104 using memory controller 116. Memory controller 116 provides the video data to temporary on-chip storage (e.g., frame buffer 114 or other buffers (not shown)) and/or to one or more video processing circuits (e.g., video processors 106, 108, 110, and 112). The video processing modules may decompress (i.e., decode, uncompress, or expand) the compressed video data to recover uncompressed (i.e., raw) video data. Video SoC 102 may write uncompressed video data to system memory 104 for subsequent use by one or more of video processors 106, 108, 110, and 112. Video processors 106, 108, 110, and 112 are execution units coupled in series for parallel execution, i.e., are execution units configured for pipelined operation controlled by controller 130. The output of one video processor (e.g., video processor 106) is the input for a next video processor (e.g., video processor 108) in the pipeline. The outputs are typically buffered between execution units. Video SoC 102 may include buffers on-chip or the outputs may be written and read from external buffers in memory 104. One or more video processing modules retrieve video data from frame buffer 114, another on-chip buffer, or from memory 104, perform bit-rate reduction, resolution change, and/or format conversion, and may write processed video data to frame buffer 114, another on-chip buffer, or memory 104, and/or provide the processed video data to backend display subsystem 120 for processing and output to video display 122.

Due to the large quantity of data involved, only small quantities of video data may be available to a particular video processor circuit at a particular time. Only an individual frame or a portion of an individual frame may be available for access by a particular video processor from frame buffer 114 or SoC memory controller 116. System-on-a-chip memory controller 116 reads the video data from system memory and stores it in frame buffer 114 for processing and, in some cases, SoC memory controller 116 writes processed data back to memory 104. Video SoC 102 may include a front-end display subsystem that receives video data and generates uncompressed and/or processed video data in a form usable by the back-end subsystem. Typical front-end display subsystem operations include decoding, decompression, format conversion, noise reduction (e.g., temporal, spatial, and mosquito noise reduction) and other interface operations for video data having different formats (e.g., multiple streams). Back-end display subsystem 120 delivers the uncompressed video data to a display device (e.g., video display 122, projector, or other electronic device).

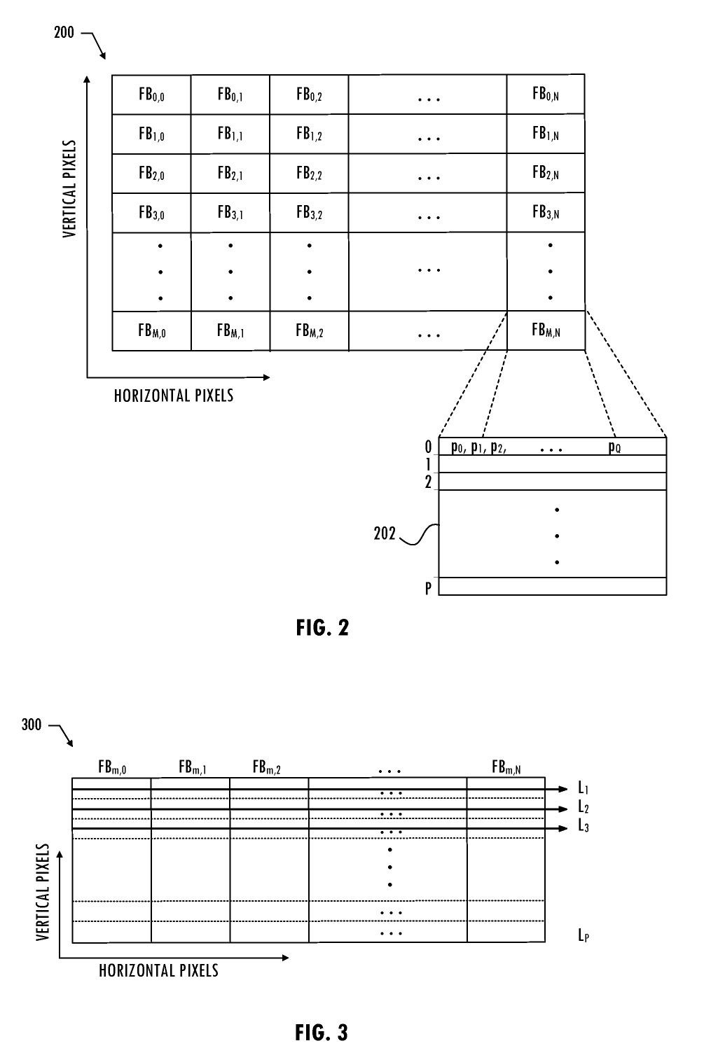

Referring to FIG. 2, in at least one embodiment of video SoC 102, the compressed video data received from system memory 104 or other external source is compressed using a high compression rate video data compression technique (e.g., MPEG-2) that partitions a frame of a video image (e.g., frame 200) into M rows and N columns of fundamental blocks (e.g., macroblocks) of pixels. An individual fundamental block is represented by FB_{m,n}, where m indicates a particular row of the M rows of fundamental blocks of frame 200 and n indicates a particular column of the N columns of fundamental blocks of frame 200. In at least one embodiment of video SoC 102, each fundamental block (e.g., fundamental block 202) includes a P×Q block of pixel data (i.e., each fundamental block includes P lines of Q pixels, e.g., a 16×16 block of pixel data). Each row of the fundamental block includes pixels forming a portion of a line of a frame of a video image.

For example, where the number of fundamental blocks that span a line of a frame of the video image is N, each row of a fundamental block includes a line portion of pixels forming 1/Nth of a line of the frame of the video image. Video processor 106 may operate on the video data in a non-linear manner, i.e., not line-by-line of the frame of the video image. In at least one embodiment, video processor 106 operates on fundamental blocks of the frame of the video image, and provides the uncompressed video data in a tiled format (i.e., fundamental block by fundamental block of uncompressed video data). In at least one embodiment, video processor 106 writes one fundamental block at a time, from left-to-right, top-to-bottom of a frame of a video image, with pixels within the block being written in a linear order. However, note that each fundamental block may include video data corresponding to multiple lines. In addition, note that tiling formats and fundamental block sizes may vary with different high-compression rate video compression techniques and decoders compliant with different video compression standards.

Referring to FIGS. 1 and 3, in at least one embodiment of SoC 102, video processors 108 and 110 may process video data in a linear manner, i.e., read or operate on frames of a video image line-by-line. In one row of fundamental blocks of a frame of a video image (e.g., row 300) the number of lines read and processed can be unrelated to the size of the fundamental block. For example, an exemplary video processor may operate on three lines of that row of fundamental blocks at a time (e.g., L₁, L₂, L₃). However, the row of fundamental blocks includes P lines of video data (e.g., L₁, L₂, L₃, . . . , L_{P}) and each fundamental block includes P line portions corresponding to the P lines of video data (e.g., l_{m,n,l}, l_{m,n,2}, l_{m,n,3}, . . . , l_{m,n,P}), where m indicates a row of fundamental blocks of a frame of a video image and n indicates a column of fundamental blocks of the screen image. The exemplary video processing block reads and processes one or more lines of video data, each line including portions of video data from multiple fundamental blocks that span a row of a frame of a video image (e.g., each line spans N fundamental blocks). Note that in at least one embodiment, an exemplary video processor reads and processes a number of lines that is not a multiple of the number of lines included in a fundamental block. Accordingly, when the video processor reads multiple lines, those lines may span multiple fundamental blocks of a frame of a video image in different rows of the frame of the video image (i.e., spanning vertically adjacent portions of the frame of the video image). The above-described disparity between the order in which an embodiment of video processor 106 produces video data and the order in which video processors 108 and 110 consume the video data may increase the complexity of processing video data.

Referring back to FIG. 1, as described above, video processors 106, 108, 110, and 112 are execution units configured for pipelined operation. The output of one video processor, referred to herein as a producer execution unit, is the input of a next video processor, referred to herein as a consumer execution unit, in the pipeline. A consumer execution unit may be any of the processor modules that accesses video data from a buffer or memory system (e.g., a memory system including SoC memory controller 116 and memory 104) and processes those data. For example, each of frame buffer 114, video processor 106, 108, 110, and 112, and back-end display subsystem 120 may access video data from a buffer or memory system, and then processes those data. A producer execution unit may be any of the processor modules that provides processed data to a buffer, the memory system, or otherwise outputs those processed data (e.g., to video display 122). Note that any particular execution unit (e.g., any of video processor 106, 108, 110, and 112, and back-end display subsystem 120) may be both a consumer execution unit and a producer execution unit.

Referring to FIG. 4, in general, producer execution unit 402 provides data (e.g., a frame or a portion of a frame of video data) to a synchronous buffer (e.g., a buffer within the SoC including the producer execution unit 402 or to a synchronous (or coherent) buffer in a memory system including storage that is external to the SoC including producer execution unit 402. In embodiments where the buffer 404 is internal to the SoC, in response to writing the last data to buffer 404 (e.g., a last line or last fundamental block of a frame of video data), producer processor 402 provides handshake signal 408 to consumer execution unit 406. In at least one embodiment, buffer 404 is synchronous to processor 402 and handshake signal 408. However, in an exemplary video application, large, on-chip buffers in an SoC are non-coherent or frames or portions of a frame of video data are read from a non-coherent system memory, processed incrementally, and written back to system memory.

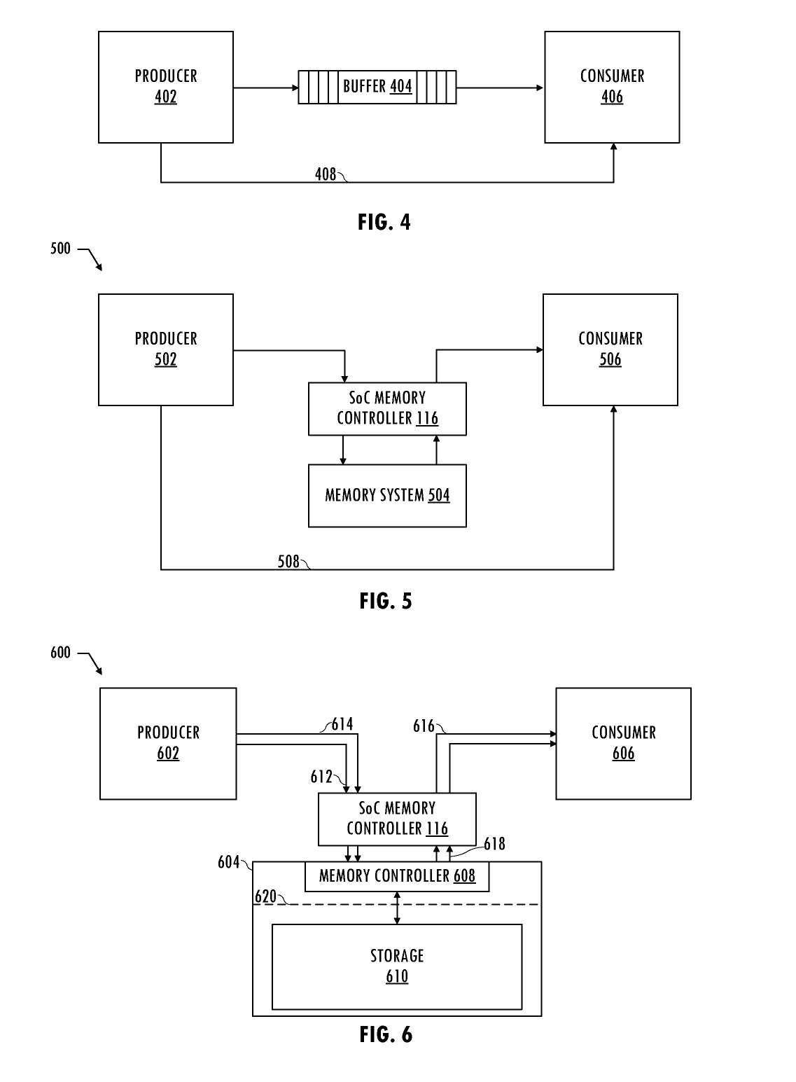

Referring to FIG. 5, a typical memory system operates non-coherently with respect to the SoC, producer execution unit 502, and consumer execution unit 506. For example, even though producer execution unit 502 writes a word to memory system 504, and generates a handshake signal indicative thereof, the word of data may not actually be committed to the memory system such that the word is available to be read out from the memory system, i.e., the memory is non-coherent with respect to the execution units of the SoC. A read by consumer execution unit 506 in response to the handshake signal may not access the most up to date information written by producer execution unit 502. In addition, the SoC may provide a different path delay for the data and a corresponding handshake signal. Accordingly, even though consumer execution unit 506 receives handshake signal 508 from producer execution unit 502, the data is not actually available at that time for a read from memory system 504. Thus, consumer processor 506 may read stale data from memory system 504 although handshake signal 508 indicates that the data is committed to memory. In addition, producer execution unit 502 may write frames of video data to memory system 504 in a different order than it is read from memory system 504 by consumer execution unit 506. For example, producer execution unit 502 may write a frame of video data to memory system 504 in fundamental blocks of pixels and consumer execution unit 506 may read a frame of video data from memory system 504 in complete lines of pixels. Conversely, producer execution unit 502 may write a frame of video data to memory system 504 in complete lines of pixels and consumer execution unit 506 may read the frame of video data from memory system 504 in fundamental blocks of pixels. Accordingly, for proper execution of consumer execution unit 506, the entire frame of video data or an entire specified portion of the frame of video data may need to be committed to memory before being accessed by the consumer execution unit 506.

A technique for synchronizing execution units of a pipelined system with a non-coherent system memory relies on the memory subsystem to provide a handshake signal to the consumer execution unit, rather than the producer execution unit. Referring to FIG. 6, in at least one embodiment of video SoC 600, producer execution unit 602 writes video data to a non-coherent memory or buffer (e.g., non-coherent memory 604) along with handshake information 614. Handshake information 614 may include a code word that indicates the end of the video data transfer or control information that is used by memory system to generate an indication of the end of the video data transfer. When all of the data has been committed to storage 610, memory controller 608 generates ready indicator 618. In response to detecting ready indicator 618, consumer execution unit 606 issues a read command and retrieves data from memory system 604. In at least one embodiment, producer execution unit 602 writes a frame of video data to memory system 604 in fundamental blocks of pixels and after the entire frame of data is committed to memory, consumer execution unit 606 reads a frame of video data from memory system 604 in complete lines of pixels. In at least one embodiment, producer execution unit 602 writes a frame of video data to memory system 604 in complete lines of pixels and after the entire frame of data is committed to memory, consumer execution unit 606 reads a frame of video data from memory system 604 in fundamental blocks of pixels. In at least one embodiment, producer execution unit 602 writes data to memory system 604 in the same format as the data is read by consumer execution unit 606 from memory system 604 in response to an indication that the data is available for a read (e.g., fundamental blocks of pixels or lines of pixels).

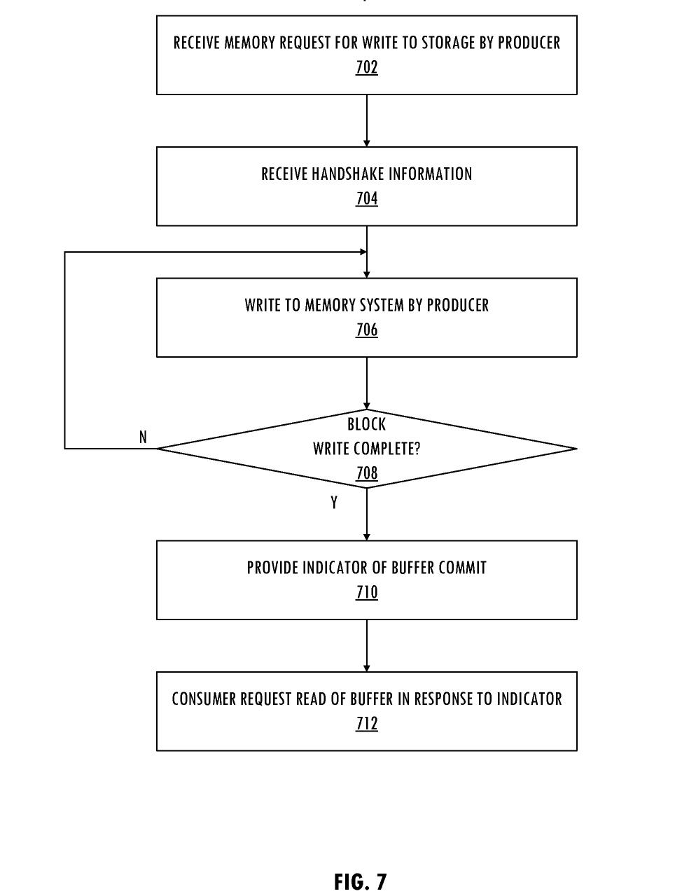

Referring to FIGS. 6 and 7, memory controller 608 receives a request for a write to storage 610 from producer execution unit 602 (702). Producer execution unit 602 provides handshake information to memory system 604 prior to writing storage 610 (704). Producer execution unit 602 writes to memory system 604 (706) until memory controller 608 detects the end of the write (708). In at least one embodiment, producer execution unit 602 provides the data and handshake information to SoC memory controller 116, which acts as an interface between the SoC and memory system 604.

In at least one embodiment, producer execution unit 602 provides the handshake information to the memory controller 608 after providing the last word of the information to be written. That handshake information may include a write to a particular location in memory system 604 that is dedicated to flagging the end of a buffer write. In at least one embodiment, the handshake information is communicated as data embedded in the buffer data, at the end or near the end, of the buffer data. For example, the handshake information may include a code word that has a value that is not naturally occurring in video data. When memory controller writes that code word to a buffer in storage 610, memory controller recognizes the code word and generates a ready indicator based thereon. In at least one embodiment, the handshake information includes a length of data to be written to the memory. Memory controller 608 uses that length to determine an ending address for the data buffer. When that ending address is written, memory controller generates ready indicator 618.

For example, memory controller 608 includes one or more counters, comparators, or other logic that determines the data has been committed to storage 610 based on a start address, finish address, total amount of data, a finish count, or other information including handshake information 612. In at least one embodiment, handshake information 612 includes a total number of words being written to memory. A counter, or other logic in memory controller 608, may increment for each word committed to storage 610. When the counter value equals the total number of words specified by producer execution unit 602, then memory controller 608 generates ready indicator 618. In at least one embodiment, memory controller 608 uses the total number of words to compute an end address and compares the computed end address to an address being written. When those values are equal, or memory controller 608 otherwise detects when producer execution unit 602 has completed a write to memory, memory controller 608 generates ready indicator 618. Memory system 604 provides an indication of availability of the data being committed to the memory system 604, ready indicator 618, to consumer execution unit 606 (710).

In at least one embodiment, consumer execution unit 606 is a general purpose processor or digital signal processing unit and ready indicator 618 includes a signal coupled to an interrupt input to consumer execution unit 606. When consumer execution unit 606 detects ready indicator 618, consumer execution unit 606 triggers an interrupt and an associated interrupt service routine performs a particular set of operations including issuing a read request to particular locations of memory system 604 (712). The interrupt input may include a vectored interrupt, indicating a particular interrupt service routine corresponding to a particular function corresponding to a particular producer execution unit 602 (712). In at least one embodiment, the indicator includes one or more bits written to a particular location that is being polled by consumer execution unit 606. In response to detecting the indicator, consumer execution unit 606 issues a memory request that reads particular locations of the memory 604 and clears the polling location or interrupt (712). In at least one embodiment, consumer execution unit 606 is an application specific processing circuit and ready indicator 618 triggers a reset of consumer execution unit 606. In response to the reset, consumer execution unit 606 performs its specific function, which includes reading associated locations in memory system 604 and processing those data according to the application (712). In response to the indicator, consumer execution unit 606 processes the appropriate data. The technique maintains coherency between pipelined execution units and otherwise non-coherent buffers or system memory regardless of whether writes and reads are performed using disparate formats.

Thus techniques for synchronizing memory accesses of pipelined execution units with a non-coherent memory structure have been described. Structures described herein may be implemented using software executing on a processor (which includes firmware) or by a combination of software and hardware. Software, as described herein, may be encoded in at least one tangible computer readable medium. As referred to herein, a tangible computer-readable medium includes at least a disk, tape, or other magnetic, optical, or electronic storage medium.

While circuits and physical structures have been generally presumed in describing embodiments of the invention, it is well recognized that in modern semiconductor design and fabrication, physical structures and circuits may be embodied in computer-readable descriptive form suitable for use in subsequent design, simulation, test or fabrication stages. Structures and functionality presented as discrete components in the exemplary configurations may be implemented as a combined structure or component. Various embodiments of the invention are contemplated to include circuits, systems of circuits, related methods, and tangible computer-readable medium having encodings thereon (e.g., VHSIC Hardware Description Language (VHDL), Verilog, GDSII data, Electronic Design Interchange Format (EDIF), and/or Gerber file) of such circuits, systems, and methods, all as described herein, and as defined in the appended claims. In addition, the computer-readable media may store instructions as well as data that can be used to implement the invention. The instructions/data may be related to hardware, software, firmware or combinations thereof.

The description of the invention set forth herein is illustrative, and is not intended to limit the scope of the invention as set forth in the following claims. For example, while the invention has been described in embodiments that process video data having a particular format, one of skill in the art will appreciate that the teachings herein can be utilized with pipelined processing modules that process other types of data having other formats. Variations and modifications of the embodiments disclosed herein, may be made based on the description set forth herein, without departing from the scope and spirit of the invention as set forth in the following claims.

What is claimed is:

1. An apparatus comprising:
a first data processor configured to communicate first data and handshake information to a non-coherent memory system; and
a second data processor coupled in a pipeline with the first data processor and configured to execute in parallel with the first data processor, the second data processor being configured to read the first data from the non-coherent memory system in response to receiving an indicator from the non-coherent memory system based on the handshake information.

2. The apparatus, as recited in claim 1, further comprising:
the non-coherent memory system comprising:
a memory controller configured to receive the first data and the handshake information, the memory controller being configured to provide the indicator in response to the first data being available for a read.

3. The apparatus, as recited in claim 2,
wherein the memory controller is configured to provide the indicator to the second data processor in response to the first data being committed to the memory system,
wherein the indicator is based on at least one of a size of a write, a write start indicator, and a write finish indicator.

4. The apparatus, as recited in claim 1, wherein the memory controller is configured to write first data out of order to the non-coherent memory system.

5. The apparatus, as recited in claim 1, wherein the first data processor writes the first data to the non-coherent memory system in a first order and the second data processor reads the first data from the non-coherent memory system in a second order.

6. The apparatus, as recited in claim 5, wherein the first order is a non-linear order and the second order is a linear order.

7. The apparatus, as recited in claim 5, wherein the first order is based on fundamental blocks of a frame of video data and the second order is based on lines of the frame of video data.

8. The apparatus, as recited in claim 1, wherein the indicator is a control bit or a message.

9. The apparatus, as recited in claim 1, wherein the indicator triggers an interrupt in the second data processor.

10. A method comprising:
writing first data to a non-coherent memory system, the data being received from a first processor in a pipeline of processors executing in parallel;
providing handshake information to the non-coherent memory system;
detecting an indicator by a second processor of the pipeline of processors, the indicator being based on the handshake information and indicating that the first data is available for a read; and
reading the first data from the non-coherent memory system in response to detecting the indicator.

11. The method, as recited in claim 10, further comprising:
storing the data in the non-coherent memory system; and
receiving the handshake information from the first processor.

12. The method, as recited in claim 10, further comprising:
generating the indicator based on the handshake information; and
providing the indicator to the second processor.

13. The method, as recited in claim 10, wherein the first data processor writes the first data to the non-coherent memory system in a first order and the second data processor reads the first data from the non-coherent memory system in a second order.

14. The method, as recited in claim 13, wherein the first order is a non-linear order and the second order is a linear order.

15. The method, as recited in claim 13, wherein the first order is based on fundamental blocks of a frame of video data and the second order is based on lines of the frame of video data.

16. The method, as recited in claim 10, wherein the indicator is a control bit or a message.

17. The method, as recited in claim 10, further comprising:
triggering an interrupt in the second processor in response to the indicator.

18. An apparatus comprising:
means for providing first data and handshake information to a means for storing data non-coherently to the means for providing first data;
means for processing the first data in parallel with the means for providing in response, the means for processing reading the first data from the means for storing in response to detecting an indicator from the means for storing.

19. The apparatus, as recited in claim 18, further comprising:
the means for storing the data non-coherently to the means for providing first data and the means for processing the first data in parallel, the means for storing comprising means for generating the indicator based on the handshake information.

20. The apparatus, as recited in claim 18, wherein the means for providing writes the first data to the means for storing in a first order and the means for processing reads the first data from the means for storing in a second order.
